(19) United States
(12) Patent Application Publication
(10) Pub. No.: US 2016/0201500 A1
(43) Pub. Date: Jul. 14, 2016

(54) METHOD FOR OPERATING A STEAM TURBINE WITH TWO STEAM SUPPLY LINES

(71) Applicant: SIEMENS AKTIENGESELLSCHAFT, München (DE)

(72) Inventors: Simon Hecker, Recklinghausen (DE); Christian Musch, Mulheim an der Ruhr (DE); Heinrich Stüer, Haltern (DE)

(73) Assignee: Siemens Aktiengesellschaft, Munich (DE)

(21) Appl. No.: 14/911,838

(22) PCT Filed: Aug. 5, 2014
(86) PCT No.: PCT/EP2014/066775

§ 371 Date: Feb. 12, 2016

(30) Foreign Application Priority Data
Aug. 23, 2013 (EP) 13181441.0

(51) Int. Cl. F01D 17/14; F01K 13/02

(52) U.S. Cl. CPC F01D 17/145; F01K 13/02; F05D 2270/334; F05D 2220/31

(57) ABSTRACT

A steam turbine arrangement and a method for operating a steam turbine, wherein the steam turbine is supplied with steam via a first valve in a first steam supply line and via a second valve in a second steam supply line. The valves are controlled asymmetrically so that in the event of unwanted vibrations measured by acceleration sensors one valve closes and the other valve opens in order to ensure the desired total mass flow.

### CROSS REFERENCE TO RELATED APPLICATIONS

This application is the U.S. National Stage of International Application No. PCT/EP2014/066775 filed Aug. 5, 2014, and claims the benefit thereof. The International Application claims the benefit of European Application No. EP13181441 filed Aug. 23, 2013. All of the applications are incorporated by reference herein in their entirety.

### FIELD OF INVENTION

The invention relates to a method for operating a steam turbine comprising a first steam supply line connected to the steam turbine and a second steam supply line, and also a first valve arranged in the first steam supply line and a second valve arranged in the second steam supply line.

### BACKGROUND OF INVENTION

In steam power plants, steam is generated in a steam generator, which steam is conducted via feed lines to the steam turbine. The feed lines issue into steam supply lines. Valves which regulate the steam throughflow are installed in the steam supply lines. Thus, one or more valves are installed upstream of the steam turbine for the purposes of regulating the steam turbine power. Various operating modes of a steam turbine are conceivable. For example, it is possible for the steam turbine to be operated at full load. A further possibility is for the steam turbine to be operated at part load. This means that not the entire mass flow generated in the steam generator flows into the steam turbine through the valves.

During said part-load operation, the valves are adjusted slightly in a closing direction such that only a part of the maximum possible total mass flow can flow into the steam turbine. However, the valves tend to vibrate during such part-load operation. This is because, owing to throttling at part load, the flow states in the valve can change, and possibly lead to excitation of the entire structure formed from valve and lines. This is to be regarded as critical because, owing to the temporally changing and possibly cyclically repeating loads, the components are subject to intense loading, which under some circumstances could lead to cracks in the components, which must be avoided.

Furthermore, under some circumstances, inadmissibly high transient forces on the valve disk could arise, leading to damage of the valve as a whole.

The problem of the tendency of the valves to vibrate during part-load operation could be counteracted by either redeveloping a valve of said type or installing a different valve, which however leads to downtime and material costs.

### SUMMARY OF INVENTION

It is an object of the invention to provide a method with which vibrations can be avoided.

Furthermore, it is an object of the invention to specify a steam turbine arrangement, the valves of which do not lead to vibrations.

Said object is achieved by way of a method for operating a steam turbine comprising a first steam supply line connected to the steam turbine and a second steam supply line, and also a first valve arranged in the first steam supply line and a second valve arranged in the second steam supply line, wherein, in the event of vibrations of the first valve and/or of the second valve, the first valve adjusts in a closing direction and the second valve adjusts in an opening direction.

Thus, it is proposed according to the invention that, in the case of a steam power plant which has more than one valve, the valves be operated so as to be actuated asymmetrically if inadmissible valve vibrations arise. These are to be understood to mean mechanical vibrations. Such mechanical vibrations affect the structure composed of valve and lines. According to the invention, this is performed by virtue of a critical operating state of an individual valve being identified. In order that the mass flow into the steam turbine is uniform, the second valve, which is not in the critical operating state, is adapted to the critical operating state of the first valve. This means that the valve opening operations are configured oppositely to one another. For example, when the first valve, which is in the critical operating state, adjusts in a closing direction, the second valve, which is not in the critical operating state, adjusts in an opening direction, in order that the total mass flow conducted into the steam turbine thereby does not change.

The mass flow through the first valve and the second valve is regulated by way of the valve opening operations. An adjustment of a valve in a closing direction means that the mass flow is reduced, and the valve orifice is reduced in size. An adjustment of a valve in an opening direction means that the mass flow is increased, and the valve orifice is increased in size. In this way, the critical operating state of the first valve can be quickly bridged, and a uniform change in mass flow nevertheless provided.

Advantageous refinements are specified in the subclaims.

Accordingly, in a first advantageous refinement, the first acceleration sensor is arranged in the first valve and a second acceleration sensor is arranged in the second valve for the purposes of detecting the inadmissible valve vibrations.

For the detection of the critical operating state, therefore, a physical value is determined, which is performed by way of an acceleration sensor. This means that the position of the valve body can be determined, and a possibly critical operating state diagnosed from the data. If such a critical operating state exists, the operating state of the second valve is checked by way of an acceleration sensor situated in the second valve, and the countermeasure according to the invention is implemented, which consists in the valve bodies being operated asymmetrically with respect to one another. In other words: the two valves are regulated asymmetrically such that, in the event of vibrations occurring, one valve adjusts in a closing direction and the other valve adjusts in an opening direction, with the aim of setting the desired total mass flow and, at the same time, remaining in the hazardous operating range of the individual valve for the shortest possible time.

Such a method according to the invention can advantageously be implemented retroactively in existing steam power plants. Programming of the valve controller is possible, which leads to low outlay. Advantageously, downtime is thereby substantially avoided.

The invention can likewise advantageously be implemented after steam turbine refurbishment in a steam power plant or in the event of upgrading of a steam power plant. This is because, through the active monitoring and adaptive avoidance strategy for valve vibrations, damage in the valves can be substantially prevented.

In an advantageous refinement, the first valve and the second valve are adjusted in a closing direction and in an opening direction such that a predefined total steam mass flow into the steam turbine is realized.

It is thus possible for the steam turbine to be operated in a desired power range despite undesired valve vibration.

In advantageous refinements, the invention can be used in steam power plants having more than two valves. Thus, the invention can be used in steam power plants with three, four or more valves, for example. According to the invention, the valves are operated asymmetrically with respect to one another.

Furthermore, the object is achieved by way of a steam turbine arrangement having a steam turbine and having a first steam supply line and a second steam supply line, wherein a first valve is arranged in the first steam supply line and a second valve is arranged in the second steam supply line, wherein a first acceleration sensor is arranged in the first valve and a second acceleration sensor is arranged in the second valve. Forces on the valves are determined by way of the acceleration sensors. Vibrations can be detected in this way.

The invention will now be discussed in more detail on the basis of an exemplary embodiment.

The exemplary embodiment illustrated in the figures shows the invention in schematic form.

### BRIEF DESCRIPTION OF THE DRAWINGS

In the figures:

FIG. 1 shows a schematic overview of a steam power plant according to the invention,

FIG. 2 is an illustration of mass flows.

### DETAILED DESCRIPTION OF INVENTION

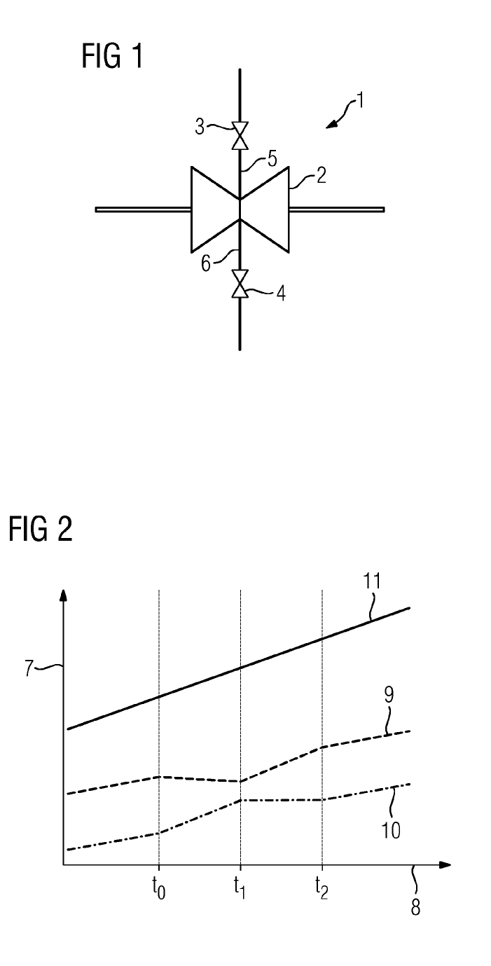

FIG. 1 shows a part of a steam power plant 1 comprising a steam turbine 2 and a first valve 3 and a second valve 4. The steam turbine 2 is formed with guide blades and rotor blades (not illustrated in any more detail) and is supplied with steam from a steam generator (not illustrated in any more detail) via a first steam supply line 5 and a second steam supply line 6.

The first valve 3 is arranged in the first steam supply line 5. The second valve 4 is arranged in the second steam supply line 6. Both the first valve 3 and the second valve 4 comprise a valve body (not illustrated in any more detail) which is designed to be movable relative to a valve disk. A movement of the valve body toward the valve disk leads to an adjustment of the valve in a closing direction. A movement of the valve body away from the valve disk leads to an adjustment of the valve in an opening direction. A valve adjusting in an opening direction leads to an increase of the steam mass flow through the valve. A movement of the valve body toward the valve disk leads to a reduction of the steam mass flow.

The first valve 3 and the second valve 4 may be of structurally identical design. In alternative embodiments, the first valve 3 and the second valve 4 may be designed differently from one another. The steam turbine 2 is of two-channel design in the embodiment illustrated in FIG. 1. In alternative embodiments, the steam turbine 2 may be of single-channel design.

The steam turbine 2 is now operated as follows:

A first acceleration sensor (not illustrated) which is arranged in the first valve 3 detects a movement of the valve body. Likewise, a second acceleration sensor (not illustrated) is arranged in the second valve 4 and is designed to detect movements of the valve body. If the first acceleration sensor or the second acceleration sensor detects an inadmissible valve vibration, the first valve 3 and the second valve 4 are operated asymmetrically with respect to one another. This means that, in this case, regulation is implemented which causes the first valve 3 to be adjusted in a closing direction and the second valve 4 to be adjusted in an opening direction. Here, the regulation is configured such that the first valve 3 and the second valve 4 regulate the mass flow by way of mutually opposite movements. This means that an adjustment of one valve, for example the first valve 3, in a closing direction leads to an adjustment of the second valve 4 in an opening direction, or vice versa.

This asymmetric regulation of the valve opening operation is such that, in the event of vibrations occurring, the desired total mass flow, made up of the mass flow through the first valve 3 and the mass flow through the second valve 4, is as far as possible not changed.

FIG. 2 shows the mass flow on the Y axis and the time on the X axis. At the time tₒ symbolized by the dashed line, a valve vibration in the second valve 4 is detected. The middle line 9 shows the mass flow through the second valve 4. Up until the time t₀, the profile of the steam mass flow through the second valve 4 is uniform. At the time t₀, valve vibrations are detected, which lead to an adjustment of the second valve 4 in a closing direction. According to the invention, it is now the case, as symbolized by the lower line 10, that the steam mass flow is regulated by way of the first valve 3. This means that, at the time t₀, the first valve 3 adjusts in an opening direction such that the steam mass flow is increased. This takes place until the time t₁, at which the conditions are reversed until the time t₂. That is to say, the first valve 3 adjusts in a closing direction such that the steam mass flow illustrated by the lower line 10 decreases, and the second valve 4 adjusts in an opening direction, such that the steam mass flow illustrated by the middle line 9 increases. At the time t₂, the valve vibrations have been eliminated, such that, proceeding from the time t₂, the profile of the steam mass flows illustrated by the middle line 9 and the lower line 10 run uniformly again.

The upper line 11 shows the total steam mass flow flowing through the first valve 3 and through the second valve 4. It can be seen that the steam mass flow illustrated by the upper line 11 has no bend either at the time t₀ or at the times t₁ or t₂. Thus, the total mass flow can flow uniformly into the steam turbine 2.

1. A method for operating a steam turbine comprising:
a first steam supply line connected to the steam turbine,
a second steam supply line,
a first valve arranged in the first steam supply line, and
a second valve arranged in the second steam supply line,
wherein in the event of vibrations of the first valve and/or of the second valve, the first valve adjusts in a closing direction and the second valve adjusts in an opening direction.

2. The method as claimed in claim 1, further comprising:
a first acceleration sensor arranged in the first valve and a second acceleration sensor arranged in the second valve for detecting the inadmissible valve vibrations.

3. The method as claimed in claim 1,
wherein the first valve and the second valve adjust in a closing direction and in an opening direction such that a predefined total steam mass flow into the steam turbine is realized.

4. The method as claimed in claim 1, further comprising:
a third, fourth and further valve, which are operated asymmetrically.

5. A steam turbine arrangement comprising:
a steam turbine,
a first steam supply line and a second steam supply line,
a first valve arranged in the first steam supply line,
a second valve arranged in the second steam supply line,
a first acceleration sensor arranged in the first valve, and
a second acceleration sensor arranged in the second valve.
